(19) United States
(12) Patent Application Publication
(10) Pub. No.: US 2015/0321495 A1
(43) Pub. Date: Nov. 12, 2015

(54) METHOD OF FLAVOR OR FRAGRANCE MICRODOSING

(71) Applicant: INTERNATIONAL FLAVORS & FRAGRANCES INC., New York, NY (US)

(72) Inventor: Hilko Oosterhoof, Ugchelen (NL)

(73) Assignee: International Flavors & Fragrances Inc., Union Beach, NJ (US)

(21) Appl. No.: 14/650,218

(22) PCT Filed: Jan. 31, 2014
(86) PCT No.: PCT/US2014/013977

§ 371 Date: Jun. 5, 2015

Related U.S. Application Data
(60) Provisional application No. 61/759,513, filed on Feb. 1, 2013.

(51) Int. Cl. B41M 3/00

(52) U.S. Cl. CPC B41M 3/006

(57) ABSTRACT

This invention is a method for providing a fragrance or flavor dose on a microgram scale for use in the development and testing of fragrances and flavors.

### BACKGROUND OF THE INVENTION

There are several main criteria in the development of a fine fragrance or functional fragrance or flavor. These can be classified as emotional parameters and rational parameters. The emotional parameter is hedonism or liking and consumer research. The second emotional parameter is memorability or signature of the fine fragrance, i.e., how easy can it be recognized.

Fragrance selection is typically dependent on its top notes. During the development of a fragrance, the perfumer evaluates the creation as it evaporates off a paper blotter. As a fragrance evaporates it necessarily changes character, but the evolving fragrance must retain a consistency through these changes. Conventional methods for carrying out such analysis include the preparation of each fragrance to be tested. When considering the multitude of fragrance blends that can be created, a significant amount of starting material can be required. A reduction in the amount of test material would provide a significant cost savings to the development of new fragrances.

### SUMMARY OF THE INVENTION

This invention is a method for providing a fragrance or flavor dose on a microgram scale by printing, with a three-dimensional, high viscous inkjet a 20 to 500 micron droplet of a flavor or fragrance on a surface or in a container. In some embodiments, the flavor or fragrance is printed from a batch, which is less than one gram or less than one milliliter. In other embodiments, the surface is a scent strip.

### DETAILED DESCRIPTION OF THE INVENTION

A method for providing a fragrance or flavor dose on a microgram scale has now been developed. Using this method, high impact ingredients can be dosed on a very low level. Moreover, a fragrance or flavor with a batch size of less than one gram or 1 mL can be created and rapidly tested.

The method of this invention involves the use of three-dimensional, high viscous printing to provide 20 to 500 micron droplets of a flavor or fragrance on a surface or in a container (e.g., a bottle). The creation of droplets from high viscosity materials and selective deposition of the same at a specific location on a substrate have been described. For example, single and multi nozzle systems based upon the inkjet principle are described in WO 2004/018212, WO 2008/060149, WO 2009/028947, WO 2009/061202, WO 2010/068108. Moreover, EP 1869133, WO 2009/061201 and WO 2009/061195 describe approaches for selective deposition without extensive material adjustments.

By way of illustration, the printing system used in the method of this invention can include a high performance liquid chromatography (HPLC) pump (e.g., 50 ml), with back pressure on the material supply for the higher viscous materials. The print head can include a high viscosity print head with a wide actuator pin (e.g., Ø7 mm), without an extra filter. Such print heads are commercially available (TNO Science and Industry; Eindhoven, The Netherlands). The nozzle plate can be spark eroded stainless steel, which desirably provides a very narrow particle size distribution (i.e., mono disperse droplets) with a tolerance of approximately 1% of the droplet diameter. In particular embodiments, the droplet diameter can be varied on demand between 20 and 500 microns, depending on the nozzle diameter selected. Using such a system, droplet frequencies may be in the order of 2-140 kHz. By virtue of high pressure, flavors or fragrances having a viscosity in the range between 20 to 500 mPa·s at room temperature can be readily printed using the method of this invention. Moreover, by increasing temperature of the print head, flavors or fragrances having a viscosity of up to 900 mPa·s at room temperature can be printed.

Flavors and/or fragrances that can be used in the method of this invention include single raw materials or blends of oils. A wide variety of flavors or fragrances can be used in the method including materials such as aldehydes and alcohols, as well as some esters and ketones and lactones of high polarity. More commonly, naturally occurring plant and animal oils and exudates including complex mixtures of various chemical components are known and can be used in the method of this invention.

Examples of fragrance oils useful herein include, but are not limited to, animal fragrances such as musk oil, civet, castoreum, ambergris, plant fragrances such as nutmeg extract, cardamom extract, ginger extract, cinnamon extract, patchouli oil, geranium oil, orange oil, mandarin oil, orange flower extract, cedarwood, vetyver, lavandin, ylang extract, tuberose extract, sandalwood oil, bergamot oil, rosemary oil, spearmint oil, peppermint oil, lemon oil, lavender oil, citronella oil, chamomile oil, clove oil, sage oil, neroli oil, labdanum oil, eucalyptus oil, verbena oil, mimosa extract, narcissus extract, carrot seed extract, jasmine extract, olibanum extract, rose extract and mixtures thereof.

Other examples of suitable fragrance oils include, but are not limited to, chemical substances such as acetophenone, adoxal, aldehyde C-12, aldehyde C-14, aldehyde C-18, allyl caprylate, ambroxan, amyl acetate, dimethylindane derivatives, α-amylcinnamic aldehyde, anethole, anisaldehyde, benzaldehyde, benzyl acetate, benzyl alcohol and ester derivatives, benzyl propionate, benzyl salicylate, borneol, butyl acetate, camphor, carbitol, cinnamaldehyde, cinnamyl acetate, cinnamyl alcohol, cis-3-hexanol and ester derivatives, cis-3-hexenyl methyl carbonate, citral, citronellol and ester derivatives, cumin aldehyde, cyclamen aldehyde, cyclo galbanate, damascones, decalactone, decanol, estragole, dihydromyrcenol, dimethyl benzyl carbinol, 6,8-dimethyl-2-nonanol, dimethyl benzyl carbinyl butyrate, ethyl acetate, ethyl isobutyrate, ethyl butyrate, ethyl propionate, ethyl caprylate, ethyl cinnamate, ethyl hexanoate, ethyl valerate, ethyl vanillin, eugenol, exaltolide, fenchone, fruity esters such as ethyl 2-methyl butyrate, galaxolide, geraniol and ester derivatives, helional, 2-heptonone, hexenol, α-hexylcinnamic aldehyde, hydroxycitronellal, indole, isoamyl acetate, isoeugenol acetate, ionones, isoeugenol, isoamyl iso-valerate, iso E super, limonene, linalool, lilial, linalyl acetate, lyral, majantol, mayol, melonal, menthol, p-methylacetophenone, methyl anthranilate, methyl cedrylone, methyl dihydrojasmonate, methyl eugenol, methyl ionone, methyl-β-naphthyl ketone, methylphenylcarbinyl acetate, mugetanol, γ-nonalactone, octanal, phenyl ethyl acetate, phenyl-acetaldehyde dimethyl acetate, phenoxyethyl isobutyrate, phenyl ethyl alcohol, pinenes, sandalore, santalol, stemone, thymol, terpenes, triplal, triethyl citrate, 3,3,5-trimethylcyclohexanol, γ-undecalactone, undecenal, vanillin, veloutone, verdox and mixtures thereof.

Additional suitable fragrance oils can be found in U.S. Pat. Nos. 4,145,184, 4,209,417, 4,515,705, and 4,152,272, all of which are incorporated herein by reference.

In accordance with one embodiment of the method of the invention, fragrance and/or flavor blends or mixtures are provided onto a surface, e.g., a scent strip or other absorbent paper to evaluate scent or a fragrance sampler card or insert. In another embodiment of the method of the invention, the fragrance and/or flavor blends or mixtures are provided into a container, e.g., a bottle, vial, tube or the like, to compound a fragrance and/or flavor blend.

In some embodiments, the fragrance or flavor is provided at a droplet diameter of between 20 and 500 microns. The smaller droplets can be obtained with a smaller nozzle diameter and higher pressures, whereas a larger nozzle diameter and lower pressures are used to obtain larger droplet sizes. In addition, with smaller nozzle diameters, a higher frequency of droplets can be applied onto the surface or in the container.

The method of this invention can be carried out at any suitable temperature that does not alter the smell of a fragrance or taste of a flavor. In certain embodiments, the method is carried out at or about room temperature (e.g., 20-25° C.). However, when the viscosity of a flavor or fragrance is high, the flavor or fragrance can be heated to, e.g., 32 to 80° C. without altering the taste or smell of the flavor or fragrance, respectively.

Given the small amounts of starting material and micro dose droplets of flavors or fragrances that are used in the method of this invention, this method finds application in the development and testing of a plethora of different fragrance and/or flavor combinations in an efficient and low cost manner. In addition, this invention finds use in providing microdoses of high impact fragrances, e.g., on magazine or direct mail fragrance sampler inserts, or in compounding new fragrances or flavors.

The invention will be further described in the following examples, which do not limit the scope of the invention described in the claims.

### EXAMPLE 1

### Mono Dispersed Droplets of Perfumes

Four different perfumes were prepared including 75% galaxolide, 50% galaxolide, orange oil, and diethyl-phthalate. Droplet generation tests were carried out to determine if the materials could be processed. This analysis included sample collection of perfume (50% galaxolide and orange oil) that had been printed one time (no recycling); sample collection of perfume (50% galaxolide and orange oil) that had been printed 50 times (recycling); and sample collection of perfume (50% galaxolide and orange oil) that had been printed 100 times (recycling). All tests were performed at room temperature (˜21° C.) with the exception of the 75% galaxolide. Because 75% galaxolide had a viscosity above the limit of the printing system, the print head was heated at 40° C.

The pump set up was a 50 mL HPLC pump with back pressure on the viscous material supply. The print head was a high TNO high viscosity print head with a wide actuator pin (Ø7 mm) without an extra filter. The nozzle plate was spark eroded 125 μm stainless steel.

The analysis was carried out by taking a snap shot of the generated droplet stream. The droplets were visualized by stroboscopic light at the same frequency at which the droplets were generated. In this respect, a picture does not show one droplet, but a projection of n droplets, with n being the generation frequency. For example at a frequency of 10 kHz, the picture showed 10000 droplets.

The results of this analysis indicated that 50% galaxolide, Orange oil and Diethyl-phthalate were printable at room temperature and that 75% galaxolide was printable at 40° C. with backpressure on the material supply. For the low viscous materials, different flow-rates and frequencies were possible, resulting in different droplet sizes. The range of droplet sizes printed was 250-500 μm. The 75% galaxolide was printed at a relatively low frequency resulting in droplets of >500 μm. Galaxolide (30 mL of 50%) and Orange oil (30 ml) were printed for five hours resulting in 100 print actions. This analysis indicated that three-dimensional, high viscous printing technology is suitable to generate mono-disperse perfume droplets.

In addition to tests on viscosity and geometry, it is also important that the smell of the perfumes is not influenced during printing. Recycled samples were therefore analyzed for possible changes in smell. This analysis indicated that there was no different in smell after one or 100 times recycling.

What is claimed is:

1. A method for providing a fragrance or flavor dose on a microgram scale comprising printing, with a three-dimensional, high viscous inkjet a 20 to 500 micron droplet of a flavor or fragrance on a surface or in a container thereby providing a fragrance or flavor dose on a microgram scale.

2. The method of claim 1, wherein the flavor or fragrance is printed from a batch comprising less than one gram.

3. The method of claim 1, wherein the flavor or fragrance is printed from a batch comprising less than one milliliter.

4. The method of claim 1, wherein the surface comprises a scent strip.
